(19) United States
(12) Patent Application Publication
(10) Pub. No.: US 2019/0265335 A1
(43) Pub. Date: Aug. 29, 2019

(54) STATIONARY WIDE-ANGLE LIDAR

(71) Applicant: Shenzhen Suteng JuChuang Technologies Ltd. Co., Shenzhen (CN)

(72) Inventors: Chunxin Qiu, Shenzhen (CN); Letian Liu, Shenzhen (CN)

(21) Appl. No.: 16/282,651

(22) Filed: Feb. 22, 2019

(30) Foreign Application Priority Data
Feb. 27, 2018 (CN) 201810164030.4
May 28, 2018 (CN) 201810511749.0

(51) Int. Cl. G01S 7/481

(52) U.S. Cl. CPC G01S 7/4817; G01S 7/4812

(57) ABSTRACT

The present application discloses a wide-angle LiDAR system that is stationary but configured to scan and map a wide range of the surrounding without rotating. The wide-angle LiDAR system disclosed herein includes multiple pairs of light emitter and receiver. Each pair of light emitter and receiver is configured to cover a section of the surrounding. Multiple pairs of light emitter and receiver are arranged to cover contiguous sections of the surrounding.

### RELATED APPLICATIONS

This US patent application claims priority, under the Paris Convention, to CN201810164030.4 titled LiDAR Device and Control Method and filed on Feb. 27, 2018, and CN201810511749.0 titled Stationary LiDAR Device and filed on May 25, 2018, the entire content of both applications being incorporated herein in its entirety.

### FIELD OF THE INVENTION

The present disclosure relates generally to light detection and ranging (LiDAR) devices, and more specifically to stationary wide-angle LiDAR systems.

### BACKGROUND

In a laser detection and ranging device (LiDAR device), laser beams are used as light sources to generate a map of a surrounding area. Generally, a LiDAR device emits one or more laser beams and detects laser beams that are reflected by an object in the surrounding environment. By calculating the time difference between the emission time of a laser beam and detection time of a reflected laser beam, a LiDAR device can measure the distance of the reflection point on the object. After collecting distance data on multiple points located on the object, the LiDAR device can map the surface of the object. Used on driverless cars, LiDAR devices coupled with Artificial Intelligence can accomplish object recognition and obstacle avoidance.

In many LiDAR applications, e.g., in an autonomous driving vehicle (ADV), a wide-angle coverage of the surrounding is required. For example, in an ADV, the LiDAR device must map and detect not only what is in front of the vehicle but also what is on the right and left side of the vehicle. Vertically, the LiDAR device also needs to cover a reasonably large angle so that objects lower to the ground or floating up in the air are not overlooked.

In prior art, LiDAR devices rely on spinning and rotation to achieve a large view range horizontally and vertically. Precision and durability are difficult to achieve or maintain when the mechanical parts of such LiDAR devices wear out rather quickly. The present application teaches a stationary LiDAR device that can achieve a wide scanning range to ensure an accurate and comprehensive scanning of the surrounding.

### SUMMARY

Accordingly, it is an objective of the present application to disclose a wide-angle LiDAR system that scan and map a wide range of the surrounding without mechanically rotating the light emitters.

In one embodiment, a wide-angle LiDAR system comprises two or more light units. Each light unit comprises a light emitter, a light receiver and a beam splitter. The light emitter is configured to generate an outgoing laser beam. The light receiver is configured to receive an incoming laser beam. The wide-angle LiDAR system further comprises a MEMS mirror for directing the outgoing laser beam from each light unit to a respective target region for scanning the surrounding area. The total target region of the wide-angle LiDAR system is the sum of the target regions of the light units. In one embodiment, each light unit further comprises a collimator for alignment of the outgoing laser beam. In one embodiment, each light unit further comprises a focusing device for focusing the incoming laser beam.

In some embodiments, the exemplary wide-angle LiDAR system is so configured that its outgoing laser beam and incoming laser beam are co-axial. In some embodiments, the angle between the axis of any two adjacent light units is the same. In some embodiments, the target regions of the light units are contiguous and are substantially not overlapping. The target region of one light unit may adjoin the target region of an adjacent light unit. The target region of one light unit may overlap with the target region of an adjacent light unit.

In some embodiments, the beam splitter of the wide-angle LiDAR system is configured to re-direct the incoming or outgoing laser beams so that the light receiver and the light emitter can be properly positioned for product packaging. For example, in one embodiment, the beam splitter receives the outgoing laser beam through a first channel and is configured to direct the outgoing laser beam to exit the beam splitter through a second channel. The beam splitter is further configured to receive the incoming laser beam through the second channel and to direct the incoming laser beam to exit the beam splitter through a third channel. In this way, the light emitter can be positioned opposite the first channel and the light receiver can be positioned near the third channel. In some embodiments, reflective mirrors can be used to direct laser beams so that the light emitters and/or light receivers can be placed in a desirable position inside the LiDAR system.

In some embodiments, the LiDAR system further comprises an installation plate. The light receivers, beam splitters, and light emitters can be affixed onto the installation place to improve durability and reduce measurement errors. In one embodiment, the light emitters and beam splitters are placed on the upper surface of the installation plate. The light receiver of each light unit may be affixed to the lower surface of the installation plate. In some embodiments, the collimator of each light unit is located on the upper surface of the installation plate. In some embodiments, the focusing device of each light unit is located on the lower side of the installation plate.

### BRIEF DESCRIPTION OF THE DRAWINGS

These and other features of the present disclosure will become readily apparent upon further review of the following specification and drawings. In the drawings, like reference numerals designate corresponding parts throughout the views. Moreover, components in the drawings are not necessarily drawn to scale, the emphasis instead being placed upon clearly illustrating the principles of the present disclosure.

FIG. 1 is an illustration of an exemplary LiDAR system configured to scan the environment during rotation.

FIG. 2 is an illustration of an exemplary LiDAR system comprising a rotating mirror for wide-angle scanning.

FIG. 3 illustrates an exemplary wide-angle LiDAR system comprising multiple light emitters.

FIG. 4 illustrates an exemplary wide-angle LiDAR system comprising multiple light units.

FIGS. 5a-5b illustrate exemplary arrangements of the target regions of multiple light units.

FIG. 6 illustrates a cross-section view of an exemplary wide-angle LiDAR system.

FIG. 7 illustrates a perspective view of a wide-angle LiDAR system.

### DETAILED DESCRIPTION

Embodiments of the disclosure are described more fully hereinafter with reference to the accompanying drawings, in which preferred embodiments of the disclosure are shown. The various embodiments of the disclosure may, however, be embodied in many different forms and should not be construed as limited to the embodiments set forth herein. Rather, these embodiments are provided so that this disclosure will be thorough and complete, and will fully convey the scope of the disclosure to those skilled in the art.

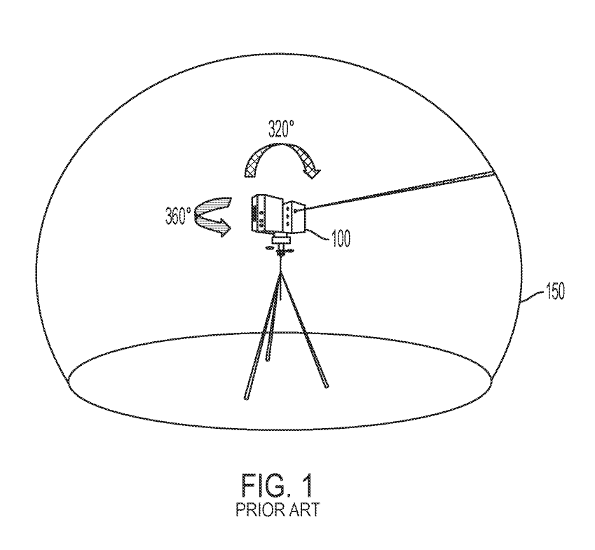

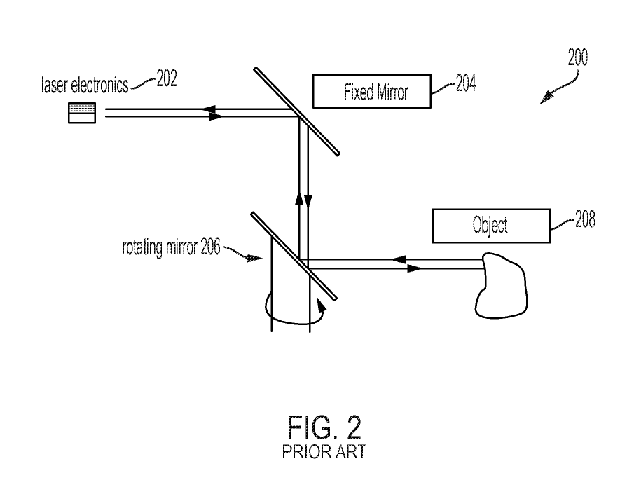

In referring to FIG. 1, a prior art LiDAR device 100 is illustrated. The LiDAR device 100 is mounted on a tripod and is configured to rotate a full 360° horizontally and 320° azimuthally. The LiDAR 100 is capable of detecting objects within the dome 150 depicted in FIG. 1. There is a high requirement of stability and speed on the LiDAR device 100 in order to achieve real time obstacle detection and accurate distance measurement. FIG. 2 illustrates another LiDAR device 200 that relies on a rotating mirror 206 to achieve a wide scanning range.

In the LiDAR device 200, the laser electronics 202 include both a laser emitter and a laser receiver. The laser emitter sends out an outgoing laser beam that, after being reflected by the fixed mirror 204, hits the rotating mirror 206 and is re-directed towards an object 208. The surface of the object 208 reflects the outgoing laser beam back towards the LiDAR device 200. The reflected laser beam becomes an incoming laser beam and hits the rotating mirror. Note that because the lightspeed is so high, the time it takes the laser beam to travel between the rotating mirror 206 and the object 208 is very small comparing to the rotation period of the mirror 206. The mirror can be regarded as staying in the same position when the incoming laser beam hits the rotating mirror 206. The incoming laser beam is directed back towards the fixed mirror 204. After being reflected by the fixed mirror 204, the incoming laser beam reaches the light receiver included in the laser electronics 202.

There are a few shortcomings with the design of both LiDAR devices 100 and 200. Oftentimes, the mechanical parts of the LiDAR device 100 and 200 wear out quickly, affecting the accuracy of the device and requiring frequent replacement. In the LiDAR device 200, the light receiver and emitter are co-located inside the laser electronics 202. Such arrangement may cause inconvenience or difficulty in product design or packing.

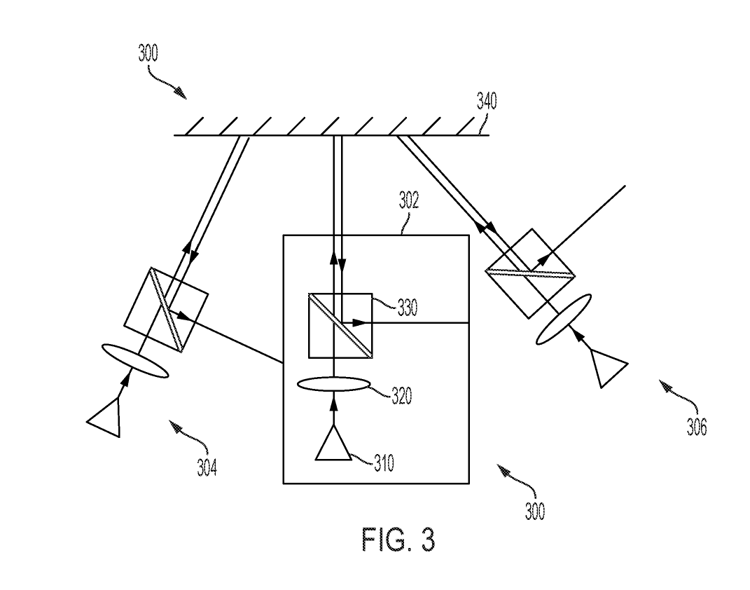

The present application discloses an innovative LiDAR device that can perform a wide-angle scanning of the environment but does not require a rotating mechanism. FIG. 3 illustrates an exemplary LiDAR device 300.

The LiDAR device 300 comprises a MEMS mirror 340 and three light units, 302, 304, and 306. MEMS stands for Micro-Electro-Mechanical Systems. MEMS devices generally include microsensors and micro-actuators that are also referred to as transducers. These micro mechanical or electro-mechanical devices are fabricated onto microchips using semiconductor techniques. A MEMS based mirror can be used to steer or deflect a laser beam in a dynamic operation. The position and orientation of the mirror is controlled by a microcontroller (FPGA) via a driver. The microcontroller is programmed to drive the movements of the mirror so the laser beam is steered in a programmed path.

The MEMS mirror 340 rotates or oscillates at a high speed and can direct a laser beam to scan at several hundred rad per second. However, the time that it takes for the laser beam to travel back and forth between the MEMS mirror 340 and an obstacle is much shorter than the rotation period of the MEMS mirror 344. The MEMS mirror 340 can be viewed as fixed when analyzing the programmed path of the laser beams.

As shown in FIG. 3, each of the three light units 302, 304, and 306 comprises a light emitter 310, an optional collimator 320, a beam splitter 330, and a light receiver (not shown). The light emitter 310 is configured to generate an outgoing laser beam. The collimator 320 is optional and is configured to align or narrow the outgoing laser beam. The beam splitter 330 is configured to split a laser beam into multiple beams. In one embodiment, the beam splitter 330 is a polarization splitter to separate p-polarization and s-polarization portions in the laser beam.

In the light unit 302, after the laser beam passes through the beam splitter 330, it reaches the MEMS mirror 340 and is reflected towards the beam splitter. In one embodiment, the reflected laser beam is re-directed by the beam splitter 330 to exit through a side surface and become an outgoing laser beam for scanning a target region.

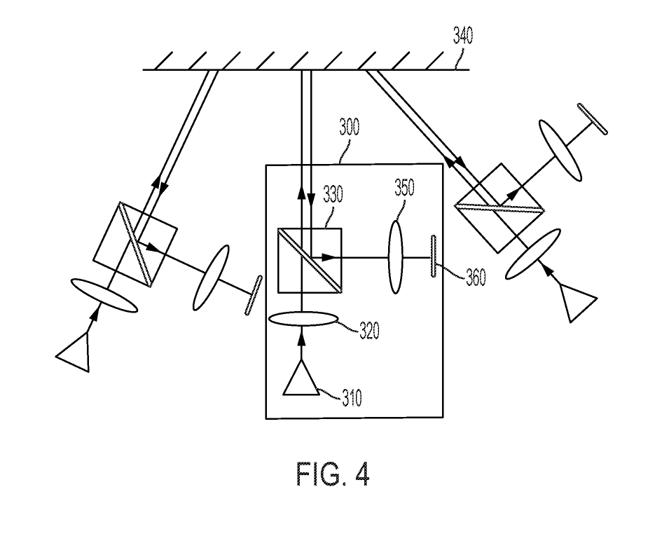

In FIG. 3, the light receiver in each light unit is not shown. FIG. 4 illustrates the light receivers, e.g., 360, for receiving the incoming laser beam that is reflected by obstacles in the target region. Examples of light receiver include Avalanche Photodiode detectors (APDs), P-i-N diode (PIN diode) light detectors, Geiger-mode APDs, single-photon detectors, and light receivers that comprise one or more arrays of any of the above enumerated light detectors. In some embodiments, a focusing device 350 may be used to focus the incoming laser beam before the incoming laser beam reaches the light receiver 360. The focusing device 350 may be optional. As shown in FIG. 4, the three light units are positioned around the MEMS mirror 340. The axis of each light unit forms an angle with the axis of the MEMS and the angle may be different for different light unit. In the light units shown in FIG. 4, the outgoing laser beam and the incoming laser beam are parallel, e.g., parallel to the axis of the light unit. Such light units are the so-called co-axial system.

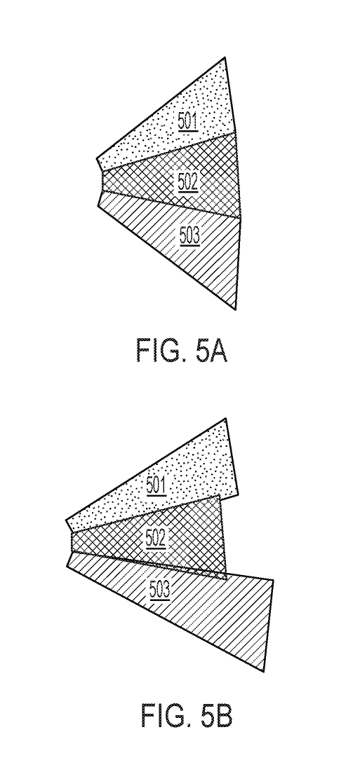

Note that in FIG. 3, the outgoing laser beam from each light unit, 302, 304, or 306, is not parallel. Each outgoing laser beam is directed towards a different target region. The total region covered by the LiDAR device 300 is the sum of the target regions covered by each light unit. By arranging multiple light units inside the LiDAR device 300, the device can cover a wide area, much wider than the target region of each light unit, as shown in FIG. 5a and FIG. 5b.

FIG. 5a and FIG. 5b illustrates two embodiments of combining a plurality of target regions to form a wide-angle scanning region. In FIG. 5a, each target region, 501, 502, or 503, adjoins each other but does not overlap. The coverage of the LiDAR device 300 is the sum of the target regions 501, 502, and 503. In some embodiments, no overlapping between adjacent target regions may cause errors or gaps. To ensure the boundaries between target regions are not missed or overlooked, the target regions may be configured to adjoin and overlap. In such case, the coverage of the LiDAR device 300 is smaller than the sum of the target regions.

In some embodiments, the LiDAR device 300 comprises N light units, with N being pre-determined based on the size of the target region of each light unit and the coverage that is desired for the LiDAR device 300. In some embodiments, each light unit may be identical and the target region of each light unit may be substantially the same. In other embodiments, the light units are configured differently, and their target regions may vary. In the device 300, each light unit may be stationary, and the target region covered by each light unit is not wide. But the device 300 can cover a wide-angle of the surrounding environment without the aforementioned shortcomings of prior art LiDAR devices. For example, the LiDAR device 300 does not require mechanical parts that facilitate fast rotational motion, making the LiDAR device 300 more durable.

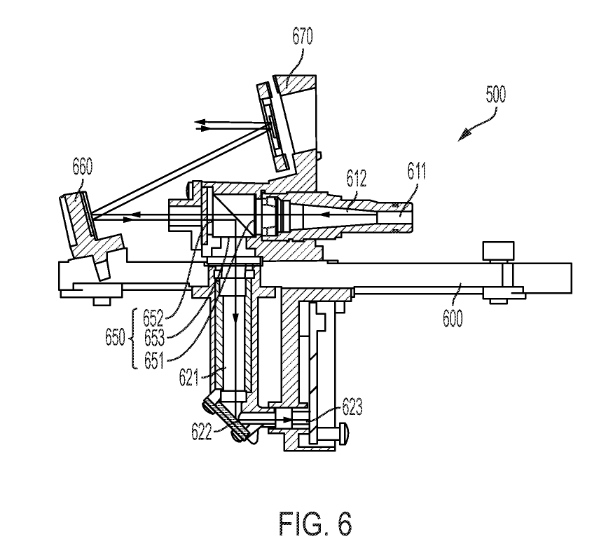

FIG. 6 illustrates a cross-section view of a LiDAR device 500 arranged on an installation plate 600. The LiDAR device 500 includes reflective mirror (or mirrors) 660 and a MEMS mirror 670 that is shared among the three light units. Only one light unit is shown in FIG. 6. The light unit comprises a light source or emitter 611, a collimator 612, a beam splitter 650, a focusing device 621, a mirror 622 and a light receiver 623. The beam splitter 650 includes three optical surfaces, 651, 652, and 653. (The optical surfaces may also be referred to as channels in the present disclosure.)

The first optical surface 651 is where the laser beam generated by the light source 611 enters the beam splitter 650. The second optical surface 652 is the exit surface for the outgoing laser beam to exit the beam splitter 650 before reaching the MEMS mirror 660. The outgoing laser beam is reflected by objects in the target region and becomes an incoming laser beam. The LiDAR device 500 is co-axial because the path of the outgoing laser beam and that of the incoming laser beam coincide. When the incoming laser beam, which is circularly polarized, passes through the beam splitter 650, the p-polarization portion of the incoming laser beam is directed towards the surface 653 and exits the beam splitter 650 through the surface 653. The incoming laser beam then passes through a focusing device 621 and is re-directed by a reflective device 622 toward the light receiver 623.

In FIG. 6, the MEMS 660, the beam splitter 650, and the light source 611 are placed on the top side of the installation plate 600. The light receiver 623 is installed on the bottom side of the installation plate. Physical separation of the light emitter and light receiver minimizes interference and reduces noises.

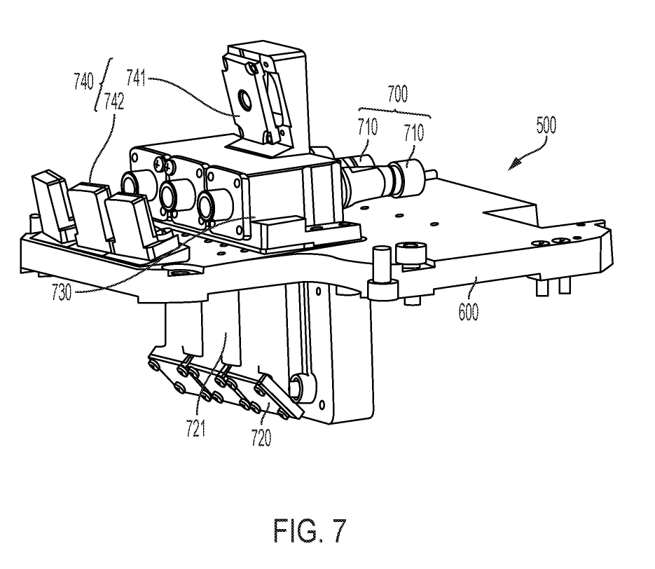

FIG. 7 illustrates a perspective view of the LiDAR device 500. In FIG. 7, the LiDAR device 500 comprises three light units affixed to the installation plate 600. The device 500 comprises a light emission system 700, which includes light emitters 710. The device 500 further comprises a light receiver system 720, a beam splitter 730, and an optical system 740. The light receiver system 720 includes light detectors 721. The optical system 740 includes a MEMS mirror 741 and reflective mirrors 742.

Although the disclosure is illustrated and described herein with reference to specific embodiments, the disclosure is not intended to be limited to the details shown. Rather, various modifications may be made in the details within the scope and range of equivalents of the claims and without departing from the disclosure.

What is claimed is:

1. A wide-angle LiDAR system, comprising two or more light units, each light unit comprising:
a light emitter configured to generate an outgoing laser beam;
a light receiver configured to receive an incoming laser beam; and
a beam splitter for splitting a laser beam into two or more beams;
wherein the wide-angle LiDAR system further comprises a MEMS mirror for directing the outgoing laser beam from each light unit to a respective target region for scanning;
wherein the total target region of the wide-angle LiDAR system is the sum of the respective target region of each light unit.

2. The wide-angle LiDAR system of claim 1, wherein each light unit further comprises a collimator for alignment of the outgoing laser beam.

3. The wide-angle LiDAR system of claim 1, wherein each light unit further comprises a focusing device for focusing the incoming laser beam.

4. The wide-angle LiDAR system of claim 1, wherein, in each light unit, the outgoing laser beam and the incoming laser beam are co-axial.

5. The wide-angle LiDAR system of claim 4, wherein the angle between the axis of any two adjacent light units is the same.

6. The wide-angle LiDAR system of claim 4, wherein the target regions of the two or more light units are contiguous and are not overlapping substantially.

7. The wide-angle LiDAR system of claim 1, wherein the target region of one light unit adjoins the target region of an adjacent light unit.

8. The wide-angle LiDAR system of claim 1, wherein the target region of one light unit overlaps with the target region of an adjacent light unit.

9. The wide-angle LiDAR system of claim 1, wherein the beam splitter is configured to receive the outgoing laser beam through a first channel and to direct the outgoing laser beam to exit the beam splitter through a second channel.

10. The wide-angle LiDAR system of claim 9, wherein the incoming laser beam enters the beam splitter through the second channel and exits the beam splitter through a third channel.

11. The wide-angle LiDAR system of claim 10, wherein the lighter emitter configured to emit the outgoing laser beam is positioned opposite the first channel and the light receiver configured to receive the incoming laser beam is positioned near the third channel.

12. The wide-angle LiDAR system of claim 1, wherein each light unit further comprises one or more reflective mirrors for directing the outgoing laser beam or the incoming laser beam.

13. The wide-angle LiDAR system of claim 1, wherein the light emitter in each light unit is a stationary laser emitter.

14. The wide-angle LiDAR system of claim 3, further comprising an installation plate, wherein the light emitter and the beam splitter of each light unit are placed on the upper surface of the installation plate, and wherein the light receiver of each light unit is affixed to the lower surface of the installation plate.

15. The wide-angle LiDAR system of claim 14, wherein the collimator of each light unit is located on the upper surface of the installation plate.

16. The wide-angle LiDAR system of claim 14, wherein the focusing device of of each light unit is located on the lower side of the installation plate.
